(19) United States
(12) Patent Application Publication
(10) Pub. No.: US 2026/0234003 A1
(43) Pub. Date: Aug. 13, 2026

(54) BLUE EMITTING GRAPHENE QUANTUM DOTS, PROCESS OF PREPARATION AND APPLICATION THEREOF

(71) Applicant: Tata Steel Limited, Jamshedpur, Jharkhand (IN)

(72) Inventors: Soumitra Ghorai, Jamshedpur, Jharkhand (IN); Kaushik Sen, Jamshedpur, Jharkhand (IN); Pratik Swarup Dash, Jamshedpur, Jharkhand (IN)

(21) Appl. No.: 19/470,749

(22) PCT Filed: Mar. 29, 2024
(86) PCT No.: PCT/IB2024/053097

§ 371 Date: Sep. 29, 2025

(30) Foreign Application Priority Data
Mar. 29, 2023 (IN) 202331023103

(51) Int. Cl. C01B 32/184; C09K 11/65; C09K 113/00

(52) U.S. Cl. CPC C01B 32/184; C09K 11/65; C01B 2204/32; C01P 2002/82; C01P 2004/04; C01P 2004/64; C01P 2006/60; C09K 2113/00

(57) ABSTRACT

The present disclosure relates to a process of preparing graphene quantum dots (GQDs) from coal tar pitch. The process of preparing the GQDs is simple, efficient, economical, and environmentally friendly. The process provides for improved yield of the GQDs. The disclosure also relates to graphene quantum dots (GQDs). The GQDs has improved quantum yield.

### TECHNICAL FIELD

The present disclosure relates to the field of chemical sciences. The present disclosure particularly relates to a simple, efficient, economical, and environmentally friendly process of preparing graphene quantum dots (GQDs) from coal tar pitch. The present disclosure also relates to graphene quantum dots (GQDs) having improved quantum yield and applications thereof.

### BACKGROUND OF THE DISCLOSURE

Graphene quantum dots (GQDs) are small pieces of graphene and have emerged as a fascinating class of highly fluorescent nanomaterials. GQDs are a new kind of nanomaterial with the combined properties of graphene and quantum dots, which are considered as a natural candidate for bioluminescent materials. GQDs have received considerable attraction as useful nanomaterials for various applications in electronics, optoelectronics, photovoltaics, drug delivery, bio-imaging and biosensing. GQDs have low cytotoxicity, excellent solubility, stable photoluminescent (PL) property and exhibits quantum confinement and edge effects.

However, size-tunable properties have become a hallmark of quantum dots and related nanostructures. Because of great scientific and technological interests, GQDs can be prepared by a top-down approach or a bottom-up approach. The former refers to the cutting of graphene-based materials into fluorescent GQDs by hydrothermal cutting, solvothermal cutting, alkali metal assisted electrochemical method, microware-assisted breaking and chemical exfoliation.

All these aforesaid techniques suffer some degree of disadvantages like requirement of complex, expensive and time-consuming procedures, high temperature and different synthetic conditions which limit their wide applications. Further, most of the GQD synthesis routes are not direct and require complicated procedures wherein the initial precursor is exposed to a strong acid or hazardous chemical solvent.

Further, it is well known that solubility of GQDs in different solvents including water is very crucial and challenging for various applications. Also, GQDs purification typically requires a very long time to remove of acid or solvent employed in the process of preparation. Purification steps for obtaining GQDs from such processes comprise neutralization technique that involves a strong base, resulting in the formation of large quantity of salt.

Thus, there is a need for a solution that addresses problems or difficulties faced in the preparation of GQDs.

The present disclosure provides an improved process of preparing GQDs that addresses the problems or difficulties faced in the preparation of GQDs. The present disclosure describes a simple, efficient, economical, and environmentally friendly process of preparing GQDs.

### STATEMENT OF THE DISCLOSURE

Accordingly, the present disclosure relates to a direct synthesis of GQDs from coal tar pitch. The process of preparing the GQDs from coal tar pitch in the present disclosure is based on acid-free polymeric amine based functionalization and hetero atom doping technique.

In an embodiment, the process of preparing the graphene quantum dots (GQDs) comprises-mixing coal tar pitch with a solvent in presence of alkaline solution to obtain a mixture; adding amine polymer to the mixture, followed by mixing; adding a doping agent to the mixture, followed by mixing and heating the mixture and separating solid product, followed by purifying the solid product to obtain the graphene quantum dots.

The present disclosure further relates to graphene quantum dots (GQDs) having quantum yield ranging from about 20% to 25%.

In an embodiment, the present disclosure further relates to use of the graphene quantum dots (GQDs) as a fluorescent nanomaterial.

### BRIEF DESCRIPTION OF THE ACCOMPANYING FIGURES

In order that the present disclosure may be readily understood and put into practical effect, reference will now be made to exemplary embodiments as illustrated with reference to the accompanying figures. The figures together with detailed description below, are incorporated in and form part of the specification, and serve to further illustrate the embodiments and explain various principles and advantages, where:

FIG. 1 illustrates a plot describing Ultraviolet (UV)-visible light absorptions spectra of aqueous solution of the GQDs of the present disclosure. The inset of the plot describes an image of aqueous solution of GQDs taken under UV light.

FIG. 2 illustrates a plot describing Fourier transform infrared (FTIR) spectra of the GQDs of the present disclosure.

FIG. 3 illustrates a plot describing Raman spectra of the GQDs of the present disclosure.

FIG. 4 illustrates High-resolution transmission electron microscopy (HRTEM) analysis data of the GQDs of the present disclosure, wherein a) describes uniform distribution of the GQD particles; b) describes HRTEM image of the GQDs; and c) describes lattice parameter of the GQDs.

FIG. 5 illustrates a plot describing photoluminescence spectra of the GQDs of the present disclosure at different excitation wavelength.

### DETAILED DESCRIPTION OF THE DISCLOSURE

Unless otherwise defined, all terms used in the disclosure, including technical and scientific terms, have meaning as commonly understood by one of ordinary skill in the art to which this disclosure belongs. By means of further guidance, term definitions are included for better understanding of the present disclosure.

As used herein, the singular forms ‘a’, ‘an’ and ‘the’ include both singular and plural referents unless the context clearly dictates otherwise.

The term ‘comprising’, ‘comprises’ or ‘comprised of’ as used herein are synonymous with ‘including’, ‘includes’, ‘containing’ or ‘contains’ and are inclusive or open-ended and do not exclude additional, non-recited members, elements or method steps.

The recitation of numerical ranges by endpoints includes all numbers and fractions subsumed within the respective ranges, as well as the recited endpoints.

The term ‘about’ as used herein when referring to a measurable value such as a parameter, an amount, a temporal duration, and the like, is meant to encompass variations of ±10% or less, preferably ±5% or less, more preferably ±1% or less and still more preferably ±0.1% or less of and from the specified value, insofar such variations are appropriate to perform the present disclosure. It is to be understood that the value to which the modifier ‘about’ refers is itself also specifically, and preferably disclosed.

Reference throughout this specification to ‘some embodiments’, ‘one embodiment’ or ‘an embodiment’ means that a particular feature, structure or characteristic described in connection with the embodiment may be included in at least one embodiment of the present disclosure, thus, the appearances of the phrases ‘in some embodiments’, ‘in one embodiment’ or ‘in an embodiment’ in various places throughout this specification may not necessarily all refer to the same embodiment. It is appreciated that certain features of the disclosure, which are for clarity, described in the context of separate embodiments, may also be provided in combination in a single embodiment. Conversely, various features of the disclosure, which are, for brevity described in the context of a single embodiment, may also be provided separately or in any suitable sub-combination.

The present disclosure relates to simple, efficient, economical, and environmentally friendly process of preparing graphene quantum dots (GQDs) from coal tar pitch.

In an embodiment of the present disclosure, the process of preparing graphene quantum dots (GQDs) from coal tar pitch is based on acid-free polymeric amine based functionalization and hetero atom doping technique.

In some embodiments of the present disclosure, the process of preparing the graphene quantum dots (GQDs) comprises—
mixing coal tar pitch with a solvent in presence of alkaline solution to obtain a mixture;
adding amine polymer to the mixture, followed by mixing;
adding doping agent to the mixture, followed by mixing; and
heating the mixture and separating solid product, followed by purification to obtain the graphene quantum dots (GQDs).

In some embodiments of the present disclosure, in the process of preparing the GQDs, the mixing of the coal tar pitch with the solvent is carried out for a duration ranging from about 1 hour to 3 hours, including all the values in the range, for instance, 1.1 hours, 1.2 hours, 1.3 hours, 1.4 hours and so on and so forth, up until 3 hours. In an embodiment, the mixing is carried out by technique including but not limited to sonication and mechanical stirring.

In some embodiments of the present disclosure, in the process of preparing the GQDs, upon adding the amine polymer to the mixture, the mixing is carried out at a temperature ranging from about 130° C. to 170° C., including all the values in the range, for instance, 131° C., 132° C., 133° C., 134° C. and so on and so forth, up until 170° C. In an embodiment, the mixing is carried out for a duration ranging from about 20 hours to 30 hours, including all the values in the range, for instance, 20.1 hours, 20.2 hours, 20.3 hours, 20.4 hours and so on and so forth, up until 30 hours.

In some embodiments of the present disclosure, in the process of preparing the GQDs, upon adding the doping agent to the mixture, the mixing is carried out for a duration ranging from about 10 hours to 20 hours, including all the values in the range, for instance, 10.1 hours, 10.2 hours, 10.3 hours, 10.4 hours and so on and so forth, up until 20 hours.

Accordingly, in an exemplary embodiment of the present disclosure, the process of preparing the GQDs from coal tar pitch comprises—
mixing the coal tar pitch with a solvent in presence of alkaline solution for a duration ranging from about 1 hour to 3 hours to obtain a mixture;
adding amine polymer to the mixture, followed by mixing at a temperature ranging from about 130° C. to 170° C., for a duration ranging from about 20 hours to 30 hours.
adding doping agent to the mixture, followed by mixing for a duration ranging from about 10 hours to 20 hours;
heating the mixture at a temperature ranging from about 130° C. to 170° C., for a duration ranging from about 10 hours to 20 hours; and
separating solid product, followed by purification to obtain the GQDs.

In some embodiments of the present disclosure, in the process of preparing the GQDs, separating the solid product upon heating the mixture is carried out by technique including but not limited to distillation and lyophilization.

In some embodiments of the present disclosure, in the process of preparing the GQDs, the separated solid product is subjected to washing and filtration, respectively. In an embodiment, the washing is carried out by distilled water. In an embodiment, the filtration is carried out by passing the washed solid product through a membrane having pore size ranging from about 0.4 mm to 0.5 mm, including all the values in the range, for instance, 0.41 mm, 0.42 mm, 0.43 mm, 0.44 mm and so on and so forth, up until 0.5 mm. In an embodiment, the membrane includes but not limited to polytetrafluoroethylene membrane and cellulose based membrane.

In some embodiments of the present disclosure, in the process of preparing the GQDs, the separated solid product is subjected to purification by technique including but not limited to dialysis and crossflow ultrafiltration.

In some embodiments of the present disclosure, in the process of preparing the GQDs, the separated solid product is subjected to purification by dialysis, wherein the filtrate obtained from the filtration is dialyzed through a dialysis membrane having molecular weight cut-off ranging from about 950 Da to 1050 Da, including all the values in the range, for instance, 951 Da, 952 Da, 953 Da, 954 Da and so on and so forth, up until 1050 Da. In an embodiment, the dialysis is carried out for a duration ranging from about 30 hours 40 hours, including all the values in the range, for instance, 30.1 hours, 30.2 hours, 30.3 hours, 30.4 hours and so on and so forth, up until 40 hours.

Accordingly, in an exemplary embodiment of the present disclosure, the process of preparing the GQDs from coal tar pitch comprises—
mixing the coal tar pitch with a solvent in presence of alkaline solution for a duration ranging from about 1 hour to 3 hours to obtain a mixture;
adding amine polymer to the mixture, followed by mixing at a temperature ranging from about 130° C. to 170° C., for a duration ranging from about 20 hours to 30 hours.
adding doping agent to the mixture, followed by mixing for a duration ranging from about 10 hours to 20 hours;
heating the mixture at a temperature ranging from about 130° C. to 170° C., for a duration ranging from about 10 hours to 20 hours; and
separating solid product by technique including but not limited to distillation and lyophilization;
washing the separated solid product by distilled water, followed by filtering the washed solid product to obtain a filtrate; and
purifying the filtrate by technique including but not limited to dialysis and cross flow ultrafiltration to obtain the GQDs.

In some embodiments of the present disclosure, in the process of preparing the GQDs, the solvent is selected from a group comprising N, N, Dimethyl formamide, N-Methyl-2-pyrrolidone, cyclohexylamine and any combinations thereof. In an embodiment, the solvent is at a concentration ranging from about 15 ml/g of the coal tar pitch to 25 ml/g of the coal tar pitch, including all the values in the range, for instance, 15.1 ml/g of the coal tar pitch, 15.2 ml/g of the coal tar pitch, 15.3 ml/g of the coal tar pitch, 15.4 ml/g of the coal tar pitch and so on and so forth, up until 25 ml/g of the coal tar pitch.

In some embodiments of the present disclosure, in the process of preparing the GQDs, the alkaline solution comprises base selected from a group comprising potassium hydroxide, sodium hydroxide, ammonium hydroxide and any combinations thereof. In an embodiment, the base in the alkaline solution is at a concentration ranging from about 75 mg/g of the coal tar pitch to 150 mg/g of the coal tar pitch, including all the values in the range, for instance, 75.1 mg/g of the coal tar pitch, 75.2 mg/g of the coal tar pitch, 75.3 mg/g of the coal tar pitch, 75.4 mg/g of the coal tar pitch and so on and so forth, up until 150 mg/g of the coal tar pitch.

In some embodiments of the present disclosure, in the process of preparing the GQDs, the amine polymer is selected from a group comprising polyethylene glycol bisamine, ethylenediamine and a combination thereof. In an embodiment, the amine polymer is at a concentration ranging from about 40 mg/g of the coal tar pitch to 60 mg/g of the coal tar pitch, including all the values in the range, for instance, 40.1 mg/g of the coal tar pitch, 40.2 mg/g of the coal tar pitch, 40.3 mg/g of the coal tar pitch, 40.4 mg/g of the coal tar pitch and so on and so forth, up until 60 mg/g of the coal tar pitch.

In some embodiments of the present disclosure, in the process of preparing the GQDs, the doping agent is selected from a group comprising sodium borohydride, boric acid, borax and any combinations thereof. In an embodiment, the doping agent is at a concentration ranging from about 100 mg/g of the coal tar pitch to 300 mg/g of the coal tar pitch, including all the values in the range, for instance, 101 mg/g of the coal tar pitch, 102 mg/g of the coal tar pitch, 103 mg/g of the coal tar pitch, 104 mg/g of the coal tar pitch and so on and so forth, up until 300 mg/g of the coal tar pitch.

Accordingly, in an exemplary embodiment of the present disclosure, the process of preparing the GQDs from coal tar pitch comprises—
mixing the coal tar pitch with a solvent having concentration ranging from about 15 ml/g of the coal tar pitch to 25 ml/g of the coal tar pitch in presence of alkaline solution having base at a concentration ranging from about 75 mg/g of the coal tar pitch to 150 mg/g of the coal tar pitch, for a duration ranging from about 1 hour to 3 hours to obtain a mixture;
adding amine polymer at a concentration 40 mg/g of the coal tar pitch to 60 mg/g of the coal tar pitch to the mixture, followed by mixing at a temperature ranging from about 130° C. to 170° C., for a duration ranging from about 20 hours to 30 hours.
adding doping agent at a concentration ranging from about 100 mg/g of the coal tar pitch to 300 mg/g of the coal tar pitch to the mixture, followed by mixing for a duration ranging from about 10 hours to 20 hours;
heating the mixture at a temperature ranging from about 130° C. to 170° C., for a duration ranging from about 10 hours to 20 hours; and
separating solid product by technique including but not limited to distillation and lyophilization;
washing the separated solid product by distilled water, followed by filtering the washed solid product to obtain a filtrate; and
purifying the filtrate by technique including but not limited to dialysis and cross flow ultrafiltration to obtain the GQDs.

In some embodiments of the present disclosure, the process provides yield of the graphene quantum dots (GQDs) in the range of about 50% to 70%, including all the values in the range, for instance, 51%, 52%, 53%, 54% and so on and so forth, up until 70%.

The process of preparing the graphene quantum dots according to the present disclosure involves combination of thermal and chemical functionalization and sonication based cutting technique, followed by hetero atom doping treatment. The inventors of the present disclosure having particularly identified that, performing the reaction of homogenous mixture of the coal tar pitch in presence of the solvent at a temperature ranging from about 130° C. to 170° C., followed by functionalizing the polycyclic aromatic hydrocarbon moiety of the coal tar pitch with the amine polymer and inserting the doping agent into the aromatic structural moiety of the coal tar pitch leads to the production of graphene quantum dots (GQDs) having significantly improved quantum yield. The process of the present disclosure does not require neutralization process by strong acids, as a result there is no formation of salt from neutralization. The purification technique employed in the process of the present disclosure is simple and environmentally friendly. Accordingly, the process of the present disclosure is an improved process for producing graphene quantum dots (GQDs) from the coal tar pitch.

The present disclosure further relates to graphene quantum dots (GQDs).

While the subsequent embodiments focus on graphene quantum dots (GQDs), the features and characteristics of the process of preparing the graphene quantum dots (GQDs) are as described by any of the embodiments above. For the sake of brevity, and avoiding repetition, each of those embodiments are not being reiterated here again. However, each of the cited embodiments completely fall within the purview of the graphene quantum dots (GQDs).

In some embodiments of the present disclosure, the graphene quantum dot has quantum yield ranging from about 20% to 25%, including all the values in the range, for instance, 20.1%, 20.2%, 20.3%, 20.4% and so on and so forth, up until 25%.

In some embodiments of the present disclosure, the graphene quantum dot has particle size ranging from about 2.5 nm to 5 nm, including all the values in the range, for instance, 2.6 nm, 2.7 nm, 2.8 nm, 2.9 nm, up until 5 nm.

Accordingly, in an exemplary embodiment of the present disclosure, the graphene quantum dot has quantum yield ranging from about 20% to 25% and has particle size ranging from about 2.5 nm to 5 nm.

In some embodiments of the present disclosure, the graphene quantum dot has excitation wavelength dependent fluorescence at a range of about 300 nm to 400 nm, including all the values in the range, for instance, 301 nm, 302 nm, 303 nm, 304 nm and so on and so forth, up until 400 nm.

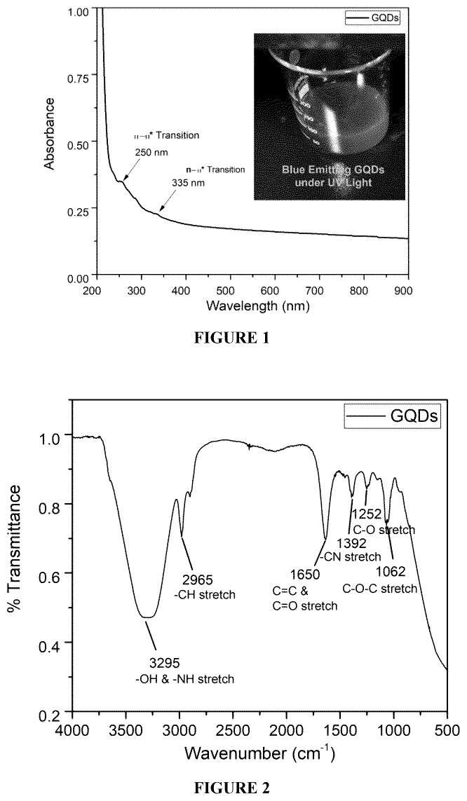

In an exemplary embodiment of the present disclosure, the graphene quantum dots (GQDs) exhibit a strong blue intense luminescence, i.e., quantum yield in the range of about 20% to 25% in visible range with an excitation wavelength dependent fluorescence at about 300 nm to 400 nm. FIG. 1 illustrates a plot describing UV-visible absorptions spectra of aqueous solution of the GQDs of the present disclosure. Further, FIG. 5 illustrates a plot describing photoluminescence spectra of the GQDs of the present disclosure at different excitation wavelength.

The present disclosure further relates to use of the graphene quantum dots (GQDs).

In some embodiments of the present disclosure, the graphene quantum dots (GQDs) can be used as a fluorescence nanomaterial. Inset of the FIG. 1 provides image of aqueous solution the GQDs of the present disclosure under UV light, wherein the GQDs exhibit strong blue intense luminescence.

The graphene quantum dots (GQDs) and the process of preparing the graphene quantum dots (GQS) described in the present disclosure provides following advantages—
coal tar pitch employed in the process of preparing the graphene quantum dots (GQDs) is cheap and economical. The coal tar pitch is totally polycyclic aromatic hydrocarbon-based carbon material and enables efficient production of the GQDs.
The process of preparing the GQDs is based on simple acid-free amine functionalized hetero atom doping technique.
The process of preparing the GQDs employ simple regenerable solvent treatment technique.
The process provides higher GQDs yield in the range of about 50% to 70%.
The GQDs exhibit blue photoluminescence property with significantly higher quantum yield in the range of about 20% to 25%.
The GQDs show uniform distribution of particle size in the range of about 2.5 nm to 5 nm.

It is to be understood that the foregoing description is illustrative not a limitation. While considerable emphasis has been placed herein on particular features of this disclosure, it will be appreciated that various modifications can be made, and that many changes can be made in the preferred embodiments without departing from the principles of the disclosure. Those skilled in the art will recognize that the embodiments herein can be practiced with modification within the spirit and scope of the embodiments as described herein. Similarly, additional embodiments and features of the present disclosure will be apparent to one of ordinary skill in art based upon description provided herein.

Descriptions of well-known/conventional methods/steps and techniques are omitted so as to not unnecessarily obscure the embodiments herein. Further, the disclosure herein provides for examples illustrating the above-described embodiments, and in order to illustrate the embodiments of the present disclosure, certain aspects have been employed. The examples used herein for such illustration are intended merely to facilitate an understanding of ways in which the embodiments may be practiced and to further enable those of skill in the art to practice the embodiments. Accordingly, following examples should not be construed as limiting the scope of the embodiments herein.

### EXAMPLES

### Example 1: Preparing Graphene Quantum Dots (GQDs)

About 10 g of coal tar pitch was treated with about 225 ml of N, N, dimethyl formamide (DMF) solvent in presence of KOH based alkaline solution. The solution was homogenously mixed by using sonicator for about 2 hours to obtain a mixture. Then about 500 g of polyethylene glycol bisamine (MW: 3000) was mixed into the mixture at a temperature of about 150° C., for a duration of about 24 hours. Subsequently, about 2 g of sodium borohydride was mixed and the mixture was heated at a temperature of about 150° C. for a duration of about 15 hours. Further, excess solvent was separated from the mixture by rotary vacuum evaporation distillation technique and a solid product was collected. The solid product was washed with distilled water and filtered through about 0.45 mm polytetrafluoroethylene membrane and the filtrate was dialyzed in a dialysis membrane having molecular weight cut-off of about 1000 Da for about 3 days to obtain the graphene quantum dots (GQDs).

The obtained GQDs were characterized by UV-visible spectroscopy, Fourier-Transform Infrared (FTIR) spectroscopy and Raman Spectroscopy. Further, the GQDs were subjected to HRTEM analysis and photoluminescence analysis.

FIG. 1 describes UV-visible absorption spectrum of aqueous solution of the GQDs. In the spectrum it can be noted that GQDs exhibit an obvious absorption peak at 250 nm with a shoulder peak at 335 nm in the UV-visible absorption spectra. The absorption peak at 250 nm is because of π-π* transition of C═C and the absorption peak at 335 nm corresponds to n-π* transition which is a characteristic feature of GQDs. These characteristic peaks signify a typical absorption of an aromatic sp² domains and represents the existence of GQDs. The inset of FIG. 1 provides optical imaging of aqueous solution of the GQDs showing blue light emission under UV light (360 nm).

FIG. 2 describes FTIR spectrum of the GQDs. In the spectrum, the peak at 1062 cm⁻¹ relates to C—O—C stretching of epoxy group. The C—O stretching of alkoxy groups was observed at 1252 cm⁻¹. The characteristics peak at 1392 cm⁻¹ was attributed to C—N stretching vibrations. An aromatic C═C stretching frequency and C═O stretching of carboxylic groups was observed at 1650 cm⁻¹. The peak at about 2965 cm⁻¹ was associated with aliphatic-CH modes. The broad peak at 3295 cm⁻¹ was associated with the O—H and N—H stretching vibration. The spectral results described above reflect that GQDs have various oxygenated functional groups such as carboxylic acid, epoxy, amine and hydroxyl groups on their aromatic surfaces that impart solubility in various solvents.

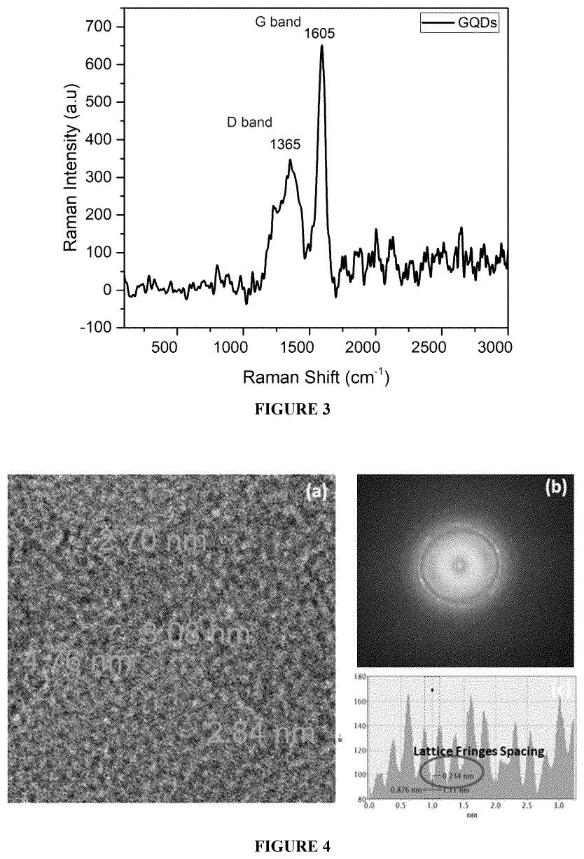

FIG. 3 describes Raman Spectroscopy of the GQDs. According to the spectra, the GQDs show “disorder” D band at 1365 cm⁻¹ and crystalline G-band at 1605 cm⁻¹ with a relative intensity ratio I_{D}/I_{G} of 0.53. The G-band at 1605 cm⁻¹ was due to E_{2g} mode at the C-point, arising from the stretching in sp² hybridized carbon, bonded either with neighbouring carbon atoms or with oxygen in the form of carboxyl groups. The D band at 1365 cm⁻¹, which was a prominent feature in the spectrum, indicates the creation of sp³ domains due to the oxidation and amine functionalization. From the spectrum it can be noted that, during the chemical functionalization, oxygen and nitrogen containing groups, including carboxyl, hydroxyl, alkoxy, epoxy and amine groups were introduced to the edges and onto the basal plane, as shown in the FTIR spectrum.

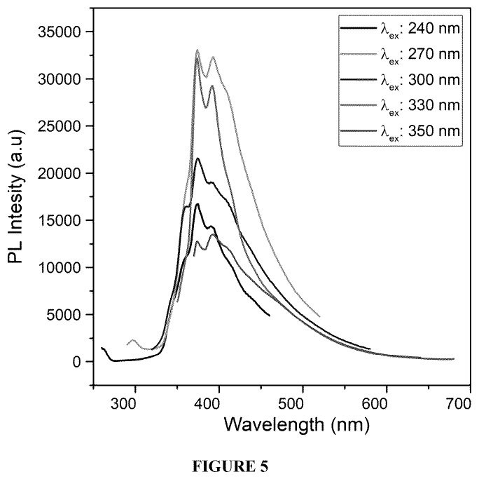

FIG. 4 describes HRTEM (high resolution transmission electron microscopy) analysis data of the GQDs, wherein a) shows uniform distribution of particles with a relatively narrow size distribution between 2.5 nm to 5 nm diameter; b) describes HRTEM image with a clear lattice fringe structure indicating high crystallinity of the GQDs; and c) describes lattice parameter of the GQDs. The lattice fringe spacing was found to be about 0.234 nm.

FIG. 5 describes photoluminescence (PL) spectra of the GQDs. The PL spectra of the GQDs were generally broad and dependent on excitation wavelength, the PL peaks shifted to longer wavelengths with a maximum intensity as the excitation wavelength was changed from 240 to 350 nm; the strongest excitation wavelength was at 330 nm which emitted bright blue photoluminescence at an emission spectra of 395 nm region.

The PL spectrum can be considered as a transition from the highest occupied molecular orbital (HOMO) to the lowest unoccupied molecular orbital (LUMO). Blue emission was attributed to the zigzag effect with a carbene-like triplet ground state σ¹π¹. The blue luminescence of the GQDs is generated from intrinsic states in the highly crystalline structure.

The photophysical properties of the GQDs are influenced by a combination of factors including their size, shape and functionalization. The quantum confinement effect was a major property of the GQDs that has a size-dependent effect on their PL properties; smaller GQDs led to a blue-shifted emission.

### Example 2: Comparative Example

Table 1 describes quantum yield of the graphene quantum dots (GQDs) obtained from precursors other than coal tar pitch by conventionally known processes and the graphene quantum dots (GQDs) obtained from coal tar pitch according to the process of the present disclosure.

TABLE 1

| | | Quantum |
|---|---|---|
| Sl. No. | Sample | Yield (Q.Y) |
| 1 | GQDs obtained from coal | 1.8% |
| 2 | GQDs obtained through hydrothermal route of cutting graphene sheets | 6.9% |
| 3 | GQDs obtained by one-pot synthesis from graphite | 9% |
| 4 | GQDs obtained by microwave bottom-up route from acetylacetone | 1% |
| 5 | GQDs obtained from coal tar pitch according to the process of the | 21.38% |
| | present disclosure | |

Data in the Table 1 demonstrates that the GQDs obtained from the coal tar pitch according to the process of the present disclosure has significantly higher quantum yield (21.38%) when compared to GQDs obtained from precursors other than coal tar pitch by conventionally known processes.

Additional embodiments and features of the present disclosure will be apparent to one of ordinary skill in art based on the description provided herein. The embodiments herein provide various features and advantageous details thereof in the description. Descriptions of well-known/conventional methods and techniques are omitted so as to not unnecessarily obscure the embodiments herein.

The foregoing description of the specific embodiments reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein.

Throughout this specification, the term ‘combinations thereof’ or ‘any combination thereof’ or ‘any combinations thereof’ are used interchangeably and are intended to have the same meaning, as regularly known in the field of patents disclosures.

As regards the embodiments characterized in this specification, it is intended that each embodiment be read independently as well as in combination with another embodiment. For example, in case of an embodiment 1 reciting 3 alternatives A, B and C, an embodiment 2 reciting 3 alternatives D, E and F and an embodiment 3 reciting 3 alternatives G, H and I, it is to be understood that the specification unambiguously discloses embodiments corresponding to combinations A, D, G; A, D, H; A, D, I; A, E, G; A, E, H; A, E, I; A, F, G; A, F, H; A, F, I; B, D, G; B, D, H; B, D, I; B, E, G; B, E, H; B, E, I; B, F, G; B, F, H; B, F, I; C, D, G; C, D, H; C, D, I; C, E, G; C, E, H; C, E, I; C, F, G; C, F, H; C, F, I, unless specifically mentioned otherwise.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. A process of preparing graphene quantum dots (GQDs), said process comprises:
a) mixing coal tar pitch with a solvent in presence of alkaline solution to obtain a mixture;
b) adding amine polymer to the mixture, followed by mixing;
c) adding doping agent to the mixture of step b), followed by mixing; and
d) heating the mixture of step c) and separating solid product, followed by purification to obtain the graphene quantum dots (GQDs).

2. The process as claimed in claim 1, wherein prior to purification, the separated solid product is subjected to washing and filtration.

3. The process as claimed in claim 2, wherein the solid product is subjected to washing by distilled water.

4. The process as claimed in claim 2, wherein the filtration is carried out by passing the washed solid product through membrane having pore size ranging from about 0.4 mm to 0.5 mm.

5. The process as claimed in claim 4, wherein the membrane is selected from a group comprising polytetrafluoroethylene membrane and cellulose based membrane.

6. The process as claimed in claim 2, wherein the purification is carried out by technique selected from a group comprising dialysis and crossflow ultrafiltration.

7. The process as claimed in claim 6, wherein the purification is carried out by dialysis, wherein the filtrate from the filtration is dialyzed through a dialysis membrane having molecular weight cut-off ranging from about 950 Da to 1050 Da, wherein the dialysis is carried out for a duration ranging from about 30 hours to 40 hours.

8. The process as claimed in claim 1, wherein the separation of the solid product is carried out by technique selected from a group comprising distillation and lyophilization.

9. The process as claimed in claim 1, wherein the mixing in step a) is carried out for a duration ranging from about 1 hour to 3 hours; wherein the mixing is carried out by technique selected from a group comprising sonication and mechanical stirring.

10. The process as claimed in claim 1, wherein the mixing in step b) is carried out at a temperature ranging from about 130° C. to 170° C., for a duration ranging from about 20 hours to 30 hours.

11. The process as claimed in claim 1, wherein the mixing in the step c) is carried out for a duration ranging from about 10 hours to 20 hours.

12. The process as claimed in claim 1, wherein the heating in the step d) is carried out at a temperature ranging from about 130° C. to 170° C., for a duration ranging from about 10 hours to 20 hours.

13. The process as claimed in claim 1, wherein the solvent is selected from a group comprising N, N, Dimethyl formamide, N-Methyl-2-pyrrolidone, cyclohexylamine and any combinations thereof.

14. The process as claimed in claim 1, wherein the solvent is at a concentration ranging from about 15 mL/g of the coal tar pitch to 25 mL/g of the coal tar pitch.

15. The process as claimed in claim 1, wherein the alkaline solution comprises base selected from a group comprising potassium hydroxide, sodium hydroxide, ammonium hydroxide; and wherein the base in the alkaline solution is at a concentration ranging from about 75 mg/g of the coal tar pitch to 150 mg/g of the coal tar pitch.

16. The process as claimed in claim 1, wherein the amine polymer is selected from a group comprising polyethylene glycol bisamine, ethylenediamine and a combination thereof; and the amine polymer is at a concentration ranging from about 40 mg/g of the coal tar pitch to 60 mg/g of the coal tar pitch.

17. (canceled)

18. The process as claimed in claim 1, wherein the doping agent is selected from a group comprising sodium borohydride, boric acid, borax and any combinations thereof; and the doping agent is at a concentration ranging from about 100 mg/g of the coal tar pitch to 300 mg/g of the coal tar pitch.

19. (canceled)

20. The process as claimed in claim 1, wherein the process provides yield of the graphene quantum dot in the range of about 50% to 70%.

21. A graphene quantum dot obtained according to claim 1, wherein the graphene quantum dot has quantum yield ranging from about 20% to 25%.

22. The graphene quantum dot as claimed in claim 19, wherein the graphene quantum dot has particle size ranging from about 2.5 nm to 5 nm; the graphene quantum dot has excitation wavelength dependent fluorescence at a range of about 300 nm to 400 nm.

23-24. (canceled)
